(19) United States
(12) Patent Application Publication
(10) Pub. No.: US 2023/0077715 A1
(43) Pub. Date: Mar. 16, 2023

(54) METHODS FOR SEGMENTING DIGITAL IMAGES, DEVICES AND SYSTEMS FOR THE SAME

(71) Applicants: Institut National de la Santé et de la Recherche Médicale (INSERM), Paris (FR); Centre National de la Recherche Scientifique, Paris (FR); Nantes Université, Nantes (FR); CHU Nantes, Nantes (FR); Université IBN TOFAÏL, Kenitra (MA)

(72) Inventors: Florent AUTRUSSEAU, Nantes (FR); Nouri ANASS, Kenitra (MA); Romain BOURCIER, Nantes (FR)

(21) Appl. No.: 17/904,174

(22) PCT Filed: Feb. 12, 2021
(86) PCT No.: PCT/EP2021/053477

§ 371 Date: Aug. 12, 2022

(30) Foreign Application Priority Data
Feb. 14, 2020 (EP) 20305143.8

(51) Int. Cl. G06T 7/136; G06T 7/11; G06T 5/00

(52) U.S. Cl. CPC G06T 7/136; G06T 7/11; G06T 5/008; G06T 2207/10088; G06T 2207/20012; G06T 2207/30016; G06T 2207/30101

(57) ABSTRACT

The present invention relates to a method for segmenting a digital image, for example to accurately segment cerebral vasculature on MRI-TOF images of a brain. The method first uses a model that imitates the perception of luminance contrasts by a human observer to accentuate a contrast between structures of interest, such as cerebral vasculature, and the image background. Then, the image is thresholded using an adaptive threshold. This enhanced segmentation method can be used to process digital images before launching further machine-implemented characterizations of the structures of interest, such as detecting and characterizing bifurcations of the cerebral vasculature for intra-cranial aneurysm prediction.

### TECHNICAL FIELD

Aspects of the present invention more generally relate to image processing methods, systems and devices for segmenting digital images.

### BACKGROUND

Medical imaging tools and techniques are increasingly used to automatically detect anatomical structures of interest in biological tissues.

For instance, in the medical and biological fields, image processing methods have been developed to automatically identify and/or classify anomalous biological elements, such as tumors, from medical images of a biological tissue of a living subject.

The anatomical structures of interest may be specific organs, or biological cells, or veins and arteries, and the like. The identification and/or classification process usually relies on identifying specific structural and geometrical features of the anatomical structures of interest.

In that regard, according to a particular example, methods have been developed to analyze and characterize brain vasculature in a subject, based on magnetic resonance images (MRI) of said subject, in order to estimate the risk of occurrence of intra-cranial aneurysms.

A common drawback of these methods is that, in order to perform accurately, the anatomical structures of interest must be clearly delineated from the image background and from the surrounding biological tissues.

In other words, there is a need for a simple and yet accurate way to segment digital images in order to highlight anatomical structures of interest on digital images, for example prior to implementing identification and/or classification processing methods on said digital images.

### SUMMARY

An object of the present invention is therefore to provide methods, systems and devices for segmenting digital images.

To that end, an aspect of the invention relates to a computer-implemented method for processing a digital image, said method comprising:
a) converting pixel intensity values of the image into luminance values using a gamma function,
b) increasing the luminance contrast between at least one structure of interest of the image and the image background,
c) segmenting the resulting image using a local segmentation threshold,

wherein increasing the luminance contrast comprises applying, on said digital image, a band-pass filter configured to increase the luminance of elements of the image having a spatial frequency comprised in a predefined interval corresponding to the spatial frequency of the structure of interest.

According to advantageous aspects, the invention may comprise one or more of the following features, considered alone or according to all possible technical combinations:
The band-pass filter is implemented by a function configured to model variations of sensitivity of a human visual system to spatial frequency variations in an image.
The cutoff frequencies of the band pass filter are chosen as a function of a size parameter of the structure of interest.
Segmenting the resulting image comprises: generating a blurred image by smoothing said resulting image, shifting the pixel intensity values of the blurred image by a fixed offset, and thresholding said resulting image by using, as a threshold cutoff value, for each pixel of said resulting image, the pixel intensity value of the shifted pixel intensity value.
The fixed offset is calculated from the standard deviation of the distribution of pixel intensity values in said resulting image, for example is equal to three times the standard deviation of the distribution of pixel intensity values in said resulting image.
The method comprises a preliminary step of removing undesired anatomical features from the acquired image.
Increasing the luminance contrast further comprises applying, on said digital image, said band-pass filter with at least one different parameter value, in order to generate at least one additional filtered image, and combining the filtered images to generate the resulting image.

According to another aspect, an image processing method comprises:

acquiring a three-dimensional digital image,

segmenting the acquired image using a method according to the method described above,

automatically identifying at least one property of the at least one structure of interest of the segmented image.

According to another aspect, said method further comprises a step of performing a diagnosis based on the identified at least one property of the at least one structure of interest of the segmented image.

According to another aspect, the invention relates to a system for processing a digital image, said system being configured to:
a) convert pixel intensity values of the image into luminance values using a gamma function,
b) increase the luminance contrast between at least one structure of interest of the image and the image background,
c) segment the resulting image using a local segmentation threshold,

wherein increasing the luminance contrast comprises applying, on said digital image, a band-pass filter configured to increase the luminance of image elements having a spatial frequency comprised in a predefined interval corresponding to the spatial frequency of the structure of interest.

According to advantageous aspects, the invention may comprise one or more of the following features, considered alone or according to all possible technical combinations:
In order to segment said resulting image, the system is further configured to generate a blurred image by applying statistical noise on a copy of said resulting image, shift the pixel intensity values of the blurred image by a fixed offset, and threshold said resulting image by using, as a threshold cutoff value, for each pixel of said resulting image, the pixel intensity value of the shifted pixel intensity value.

### BRIEF DESCRIPTION OF THE DRAWINGS

The invention will be better understood upon reading the following description, provided solely as an example, and made in reference to the appended drawings, in which:

FIG. 1 is a simplified diagram of a system for implementing a segmentation method according to embodiments of the invention;

FIG. 2 is a flowchart of an exemplary segmentation method according to embodiments of the invention;

FIG. 3 depicts an example of transformation steps applied to a digital image during the method of FIG. 2;

FIG. 4 is a flowchart of an exemplary image processing method including steps of a segmentation method according to embodiments of the invention;

FIG. 5 illustrates examples of a contrast sensitivity function adapted to be used as a band-pass filter during the method of FIG. 2.

### DETAILED DESCRIPTION OF SOME EMBODIMENTS

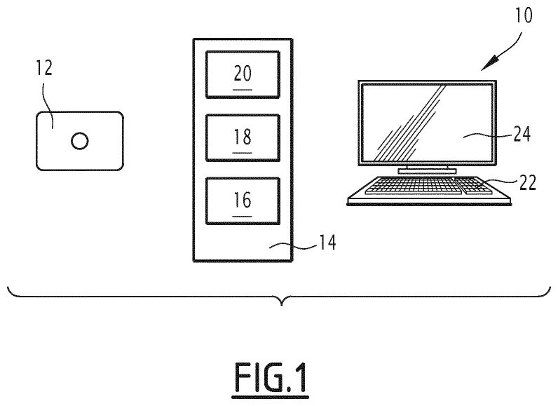

In reference to FIG. 1 is illustrated a system 10 for implementing a method for segmenting digital images.

In many embodiments, the system 10 comprises electronic circuitry. Preferably, the system 10 is a processor-based computing device.

In the illustrated example, the system 10 is a computer, such as a laptop, or a mobile computing device, or a computer server, or a cloud-based device.

More generally, the system 10 is a computer, or a computing system, or any similar electronic computing device adapted to manipulate and/or transform data represented as physical quantities within the computing system's registers and/or memories into other data similarly represented as physical quantities within the computing system's memories, registers or other such information storage, transmission or display devices.

In some embodiments, as illustrated on FIG. 1, the interaction between a computer program product 12 and the system 10 enables to carry out the image segmenting method.

In the illustrated example, the system 10 comprises a processor 14 and a human-machine interface (HMI) that may include a keyboard 22 and a display unit 24, such as a computer screen.

The processor 14 may comprise a central data-processing unit 16 (CPU), one or more computer memories 18 and a data acquisition interface 20. The interface 20 is adapted to read a computer readable medium.

The computer program product 12 comprises a computer readable medium.

For example, the computer readable medium is a medium that can be read by the interface 20 of the processor. The computer readable medium is a medium suitable for storing electronic instructions, and capable of being coupled to a computer system bus.

A computer readable storage medium may comprise, for instance, one or more of the following: a disk, a floppy disk, optical disks, CD-ROMs, magnetic-optical disks, read-only memories (ROMs), random access memories (RAMs) electrically programmable read-only memories (EPROMs), electrically erasable and programmable read only memories (EEPROMs), magnetic or optical cards, or any other type of media suitable for storing electronic instructions, and capable of being coupled to a computer system bus.

A computer program is stored in the computer readable storage medium. The computer program comprises one or more stored sequence of program instructions.

The computer program is loadable into the data-processing unit and adapted to cause execution of the method for determining when the computer program is run by the data-processing unit.

In other embodiments, the system 10 may be implemented differently and may include application specific integrated circuits (ASIC), or programmable circuits such as field programmable gate arrays (FPGA), or equivalents thereof, and more generally any circuit or processor capable of executing the functions described herein.

In many embodiments, the system 10 is adapted to acquire one or more digital images to be processed.

The digital images may be digital medical images acquired using a medical imaging apparatus, such as a magnetic resonance imaging apparatus (MRI), preferably a time-of-flight MRI apparatus (MRI-TOF), an X-ray based imaging apparatus, such as a computer tomography (CT) scanning apparatus, or any suitable imaging apparatus or combination thereof.

Said digital images may be encoded in the DICOM image format, or in any suitable format.

In many embodiments, the digital images are three-dimensional images.

Said digital images may comprise a plurality of two-dimensional images, or slices, superimposed along the direction of acquisition used by the medical imaging apparatus.

However, in other embodiments, the digital images may be two-dimensional images.

Said digital images may be stored in a computer memory of the device 10, for example in memory 28.

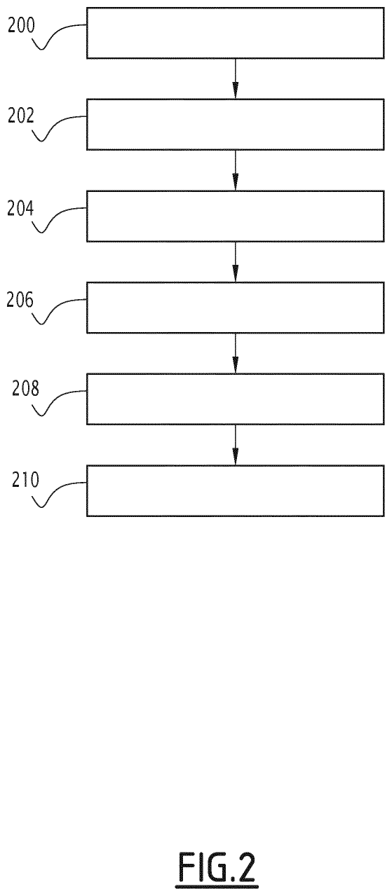

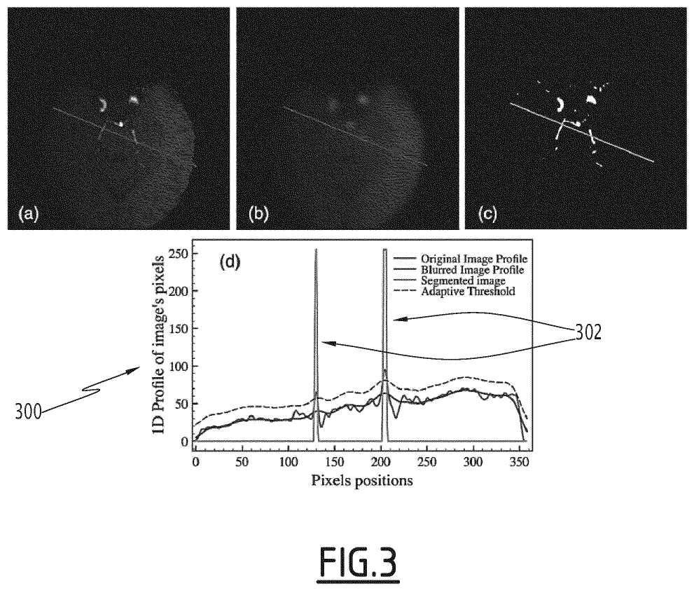

An exemplary method for segmenting images is now described in reference to FIGS. 2 and 3. For example, a goal of the method is to segment the image in order to highlight at least one structure of interest of the image.

On FIG. 3, images (a), (b) and (c) illustrate a two-dimensional slice of a digital image at three different steps of the method.

The fourth image (d) of FIG. 3 depicts a graph 300 in which the intensity value of a subset of pixels of the digital two-dimensional image aligned along a one-dimensional profile of the image (visible as a white line on images (a), (b) and (c)) is plotted as a function of the pixel position along said line. The white line is not part of the pictures themselves and is given only by way of example to better illustrate the operation of the segmentation method and the resulting differences between images (a), (b) and (c).

The method begins at block 200.

Initially, a digital image is acquired by the system 10.

For example, said acquired image is a medical image, such as a MRI-TOF, image or a digital subtraction angiography (DSA) image, or the like.

In many embodiments, the image is a grayscale digital image with pixel intensity values comprised in a predefined range, for example within the interval [0, 255] for images with an 8-bit encoding.

In the illustrated embodiments, the digital image is an image of a brain of a subject, such as a human patient. The image preferably includes brain vasculature corresponding to the so-called Circle of Willis.

Thus, in the illustrated example, the structure of interest is a vascular tree.

An objective of the method is therefore to segment the acquired digital image so as to highlight the vascular tree over the image background, said background including, for example, other biological tissue, fluids and organs unrelated to the vascular system (e.g. parenchyma, cerebrospinal fluid, etc.).

However, it is to be understood that this method is not limited to processing brain images and that many other embodiments are possible.

For example, the method could be used to segment cells in a biological tissue, and more generally to segment visible objects having a certain size distribution.

In some embodiments, the acquired image is a two-dimensional image, such as a two-dimensional digital image made of a plurality of pixels.

In what follows, the following steps and operations are directly applied to a two dimensional image for explanatory purposes.

In some other embodiments, however, the acquired image may be a three-dimensional image.

In that case, the steps and operations described herein may be applied successively on each two-dimensional slice of said digital three-dimensional image in order to process the entire three-dimensional image.

In some embodiments, at this stage, the method comprises a preliminary step of removing undesired anatomical features from the acquired image.

For example, if the image is an image of a brain, then said preliminary step comprises removing non-brain portions of the image, such as subcutaneous tissue and ocular globes.

In some examples, this removal can be performed using the “Brain Extraction Tool” method disclosed in the article “Fast robust automated brain extraction” by Stephen M. Smith, in Human Brain Mapping 17:143-155, 2002.

In some embodiments, this prior removal step may be omitted altogether.

Then, at block 202, the pixel intensity values of the image are converted into luminance values using a gamma function (e.g., a gamma correction normalization function).

In other words, the image grey level values of the image are converted into perceived luminance values (a photometric measure of light intensity).

For example, the following formula is used to compute the luminance values for each pixel of the digital image:

$$L = Lm + LM \times {( \frac{G}{255} )}^{γ}$$

where L denotes the luminance value to be computed, G denotes the pixel grey level intensity value, Lm and LM are, respectively, the minimum and maximum allowable luminance values in candela per m², and γ is a numerical value, for example comprised between 1.5 and 3.0, or preferably comprised between 1.8 and 2.3.

For example, the gamma function may be used to simulate the luminance properties of a reference video screen.

At the end of this step, the original grayscale intensity values of each pixel of the acquired digital image have been replaced with luminance intensity values. The resulting image may be referred to as “corrected image” in what follows.

Then, at block 204, the luminance contrast between at least one structure of interest of the image and the image background is increased.

According to many embodiments, increasing the luminance contrast comprises applying, on said corrected image, a band-pass filter configured to increase the luminance of image elements having a spatial frequency comprised in a predefined interval corresponding to the spatial frequency of the structure of interest.

More precisely, the filter may be applied in the frequency space of the image, e.g. on a Fourier transform of said corrected image.

Thus, the step 204 may include the following sub-steps: applying a Fourier transform to the image to compute a frequency-domain representation of the image, applying the band-pass filter to the computed frequency-domain representation, and applying an inverse Fourier transform to the frequency-domain representation to obtain a space-domain image.

In many embodiments, the band-pass filter is implemented by a function configured to model variations of sensitivity of a human visual system to spatial frequency variations in an image.

Preferably, the cutoff frequencies of the band pass filter are chosen as a function of a size parameter of the structure of interest.

In the present example, a relevant size parameter of the structure of interest is the average width of blood vessels of the vasculature in the Circle of Willis.

In many preferred embodiments, the band-pass filter is implemented by the so-called Contrast Sensitivity Function (CSF) of the Human Visual System theoretical model, as described in the article “Visible differences predictor: an algorithm for the assessment of image fidelity” by Daly S. J., in Human Vision, Visual Processing and Digital Display III, 1666, 2-15, SPIE 1992.

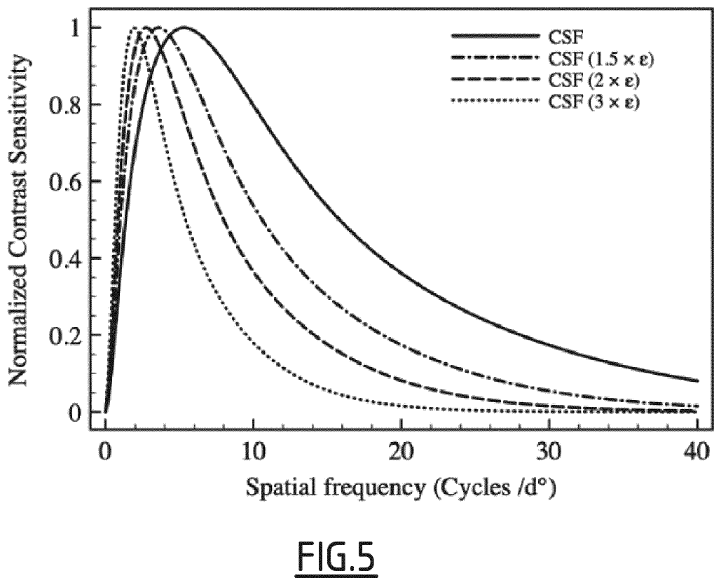

Examples of a contrast sensitivity function adapted to be used as a band-pass filter are illustrated on FIG. 5.

In practice, the Contrast Sensitivity Function (or any similar function) describes the ability of the human visual system to discriminate between various spatial frequencies (i.e., between objects of an image having different size distributions). In several embodiments, this function is used as a filter to highlight specific contrasts in the luminance-based image.

In other words, the method first uses a model that imitates the perception of luminance contrasts by a human observer to accentuate a contrast between structures of interest, such as cerebral vasculature, and the image background.

Preferably, the peak sensitivity of the filter is shifted towards lower spatial frequencies, e.g. spatial frequencies lower than or equal to 5 cycles per degree of visual angle, or lower than or equal to 3 cycles per degree.

According to an exemplary and non-limiting embodiment, the Contrast Sensitivity Function may be given by the following formula:

$$S ( ρ , θ , l , {i}^{2} , d , e ) = P \times min [ {S}_{1} ( \frac{ρ}{{r}_{a} {r}_{e} {r}_{θ}} , l , {i}^{2} ) , {S}_{1} ( ρ , l , {i}^{2} ) ]$$

expressing the sensitivity to luminance S as a function of several parameters and variables, as defined in the above-mentioned article by Daly S. J., where “P” is the absolute peak sensitivity of the Contrast Sensitivity Function, ρ is the radial spatial frequency in cycles per degree, θ is the orientation in degrees, “I” is the light adaptation level in candela per m², i² is the image size expressed in visual degrees, d is the lens accommodation due to distance (in meters), “e” is the eccentricity and rₐ,rₑ,r_{θ} are parameters that model changes in resolution due to the accommodation level, eccentricity and orientation, respectively, and the quantity S1 is given by the following formula:

S₁(ρ, l, i²)=((3.23(ρ²i²)^{-0.3})⁵+1)^{-1/5} ×Aₗερe^{-(B}^{ₗ}^{ερ)}\sqrt{1+0.006ε^{B}^{ₗ}^{ερ}}

where Aₗ and Bₗ are numerical values, “e” denotes the exponential function and ε is a frequency scaling constant, the default value of which being equal to 0.9 in this example, although other values could be chosen.

For example, to shift the filter peak sensitivity in accordance with the relevant size parameter of the structure of interest, the value of the frequency scaling constant ε may be modified.

In this example, to shift the filter peak sensitivity towards lower spatial frequencies, the value of the frequency scaling constant ε is increased from its default value, e.g. increased by a factor of 2 or 3 or by any appropriate value.

In the example illustrated on FIG. 5, values of the contrast sensitivity function (normalized Contrast Sensitivity plotted as a function of the spatial frequency expressed in cycles per degree) are shown for four different values of the frequency scaling constant ε.

At the end of step 204, regardless of the actual embodiment of the band-pass filter, the originally acquired image (the corrected image) has been transformed into a filtered image, named “resulting image” in what follows.

In some optional embodiments, step 204 may be modified to implement a multi-scale filtering process in order to increase the robustness and reliability of the segmenting method and reduce its sensitivity to noise, especially noise contained in the originally acquired images (such as Gaussian noise or impulse noise).

In practice, the band-pass filter described above may be applied separately several times onto the corrected image, each time by changing a parameter value of the band-pass filter, for example using a different value of the frequency scaling parameter ε, in order to generate several filtered images. This way, each of the filtered images is associated to a different spatial frequency.

According to a non-limiting and illustrative example, the band-pass filter is applied a first time onto the corrected image with a first value of the frequency scaling parameter ε (e.g., ε=0.9) to generate a first filtered image. The band-pass filter is applied a second time onto the corrected image with a second value of the frequency scaling parameter ε (e.g., ε=1.8) to generate a second filtered image. The band-pass filter is applied a third time onto the corrected image with a third value of the frequency scaling parameter ε (e.g., ε=2.7) to generate a third filtered image. The first, second and third filtered images are merged into a single resulting image.

In other words, increasing the luminance contrast may further comprise the following steps: applying, on the corrected image, said band-pass filter with at least one different parameter value, in order to generate at least one additional filtered image, and then combining or merging the filtered images in order to generate the resulting image. For example, the filtered images may be merged by combining their respective entropies.

Then, once step 204 is completed, said resulting image is segmented using a local segmentation threshold.

According to a preferred embodiment, segmenting the resulting image comprises three steps corresponding to blocks 206, 208 and 210 below.

At block 206, a blurred image is generated by smoothing said resulting image.

For example, a Gaussian blur filter is applied onto said resulting image in order to generate the blurred image.

In alternative embodiments, any low-pass filter may be used to smooth the image.

On FIG. 3, an example of a resulting image (i.e., the image obtained at the end of block 204) is visible as image (a). The corresponding intensity values of a subset of pixels are visible on the graph 300 as a first solid line (Original Image Profile).

The corresponding blurred image is visible as image (b). The corresponding intensity values for the same subset of pixels are depicted on graph 300 as a second solid line (Blurred Image Profile).

Then, at block 208, the pixel intensity values of the blurred image are increased by a fixed offset. In other words, the intensity levels of the blurred image are shifted upwards by said fixed offset.

On FIG. 3, the corresponding intensity values of the shifted image for the same subset of pixels are depicted on graph 300 as a dashed line (Adaptive Threshold).

Preferably, the fixed offset is calculated from the standard deviation of the distribution of pixel intensity values in said resulting image.

According to still preferred embodiments, said offset is equal to three times the standard deviation of the distribution of pixel intensity values in said resulting image.

In practice, the standard deviation is calculated for the entire resulting image, although some aberrant pixel intensity values such as zero intensity pixels or extreme intensity values (e.g. corresponding to noise or background elements) may be discarded to avoid biasing the standard deviation.

In other embodiments, the offset could be computed differently. It is however desirable that the offset is sufficiently high so as to bring the segmentation threshold above the noisy portions of the image.

Then, at block 210, the resulting image is thresholded by using, as a threshold cutoff value, for each pixel of said resulting image, the pixel intensity value of the shifted pixel intensity value.

In other words, the image is thresholded by a smoothed version of itself.

On FIG. 3, the final, segmented image is visible as image (c). The corresponding intensity values for the same subset of pixels are depicted on graph 300 as a third solid line (Segmented Image).

In this example, after the segmentation cutoff, the one-dimensional profile comprises only two peaks 302 with maximum intensity. These peaks 302 correspond to the pixel of the resulting image having a pixel intensity higher than the adaptive threshold.

This method yields better and more robust results than using a fixed global threshold for the entire image, or even using a local threshold based on a sliding window.

Using the standard deviation to compute the offset value has the advantage that the segmentation threshold follows the image topology and is able to not only preserve the structures of interest highlighted by the contrast enhancement (of block 204) but also to increase the contrast difference between the structures of interest and the rest of the image.

At the end of the process, in the final image, the elements of interest are visible and the irrelevant background elements are no longer visible.

In embodiments where the originally acquired image is a three-dimensional image, then the individual two-dimensional final images obtained independently for each run of the method may be combined into a final three-dimensional image.

The embodiments discussed above have many advantages. Using a model based on human perception criteria of luminance is a simple and effective way to filter the relevant spatial frequencies and contrasts of the relevant structures of interest of the image. Thus, the image is perceptually enhanced before applying any actual threshold.

This method yields good results and is easy to implement. The method may require as little as a few seconds to segment the entire image using the steps described above. One reason explaining this speed is that many steps, including the contrast enhancement step, involve applying a simple filter onto the image.

In comparison, many known segmentation methods commonly used to highlight brain vasculature in digital images of brain tissue are based on complex shape identification algorithms operating on an entire three-dimensional image obtained from a medical imaging apparatus. These known methods are particularly computationally intensive and may require several minutes or longer to compute and generate segmented images.

The final segmented image may optionally be used with great advantage with computer-implemented image processing methods configured to identify and/or classify structures of interest in an image, although the segmentation method can be used on its own.

In other words, the segmentation method can be used to process digital images before launching further machine-implemented characterizations.

One particular example are methods for characterizing structural features, such as detecting and characterizing bifurcations of the cerebral vasculature for intra-cranial aneurysm prediction, although many other examples and applications are possible.

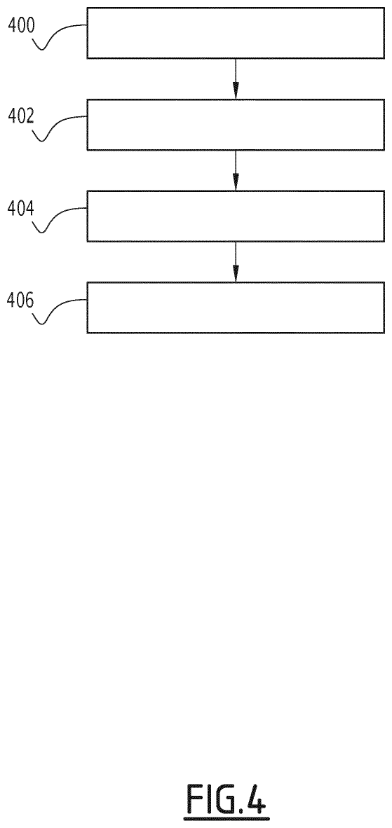

For example, as illustrated in FIG. 4, an image processing method may include a first step 400 of acquiring a digital image, in a way similar to the step 200 described above.

Said method may be implemented with the system 10 described above or with any similar system.

The acquired image may be a two-dimensional image or a three dimensional image, as explained previously.

Then, at step 402, the acquired image is segmented, using a segmentation method compliant with one of the embodiments described above, in order to highlight structures of interest.

At step 404, one or more steps are applied to the segmented image in order to extract one or more properties of the structures of interest, and/or to identify and/or classify the structures of interest.

According to some non-limiting examples, the properties may be the number of structures of interest, their size and/or any parameter representative of a dimensional or a structural property, such as aspect ratio, symmetry, or the like.

The process ends at block 406, where the results are outputted by the system.

Because the segmentation is more precise and more effective method, the entire process is thus made more reliable. In other words, the segmentation method described above is optimized to improve the global efficiency of the entire image processing method.

Other embodiments and applications are possible.

In many alternative embodiments, the method steps described above could be executed in a different order. One or more method steps could be omitted, or replaced by equivalent method steps. One or more method steps could be combined into a single step, or dissociated into different method steps, without departing from the scope of the claimed subject matter.

1. A computer-implemented method for processing a digital image, said method comprising:
a) converting pixel intensity values of the digital image into luminance values using a gamma function,
b) increasing the luminance contrast between at least one structure of interest of the digital image and the digital image background,
c) segmenting the resulting image using a local segmentation threshold,
wherein increasing the luminance contrast comprises applying, on said digital image, a band-pass filter configured to increase the luminance of image elements having a spatial frequency comprised in a predefined interval corresponding to the spatial frequency of the structure of interest.

2. The method of claim 1, wherein the band-pass filter is implemented by a function configured to model variations of sensitivity of a human visual system to spatial frequency variations in an image.

3. The method of claim 1, wherein the cutoff frequencies of the band pass filter are chosen as a function of a size parameter of the structure of interest.

4. The method according to claim 1, wherein segmenting the resulting image comprises:
generating a blurred image by smoothing said resulting image,
shifting the pixel intensity values of the blurred image by a fixed offset, and
thresholding said resulting image by using, as a threshold cutoff value, for each pixel of said resulting image, the pixel intensity value of the shifted pixel intensity value.

5. The method of claim 4, wherein the fixed offset is calculated from the standard deviation of the distribution of pixel intensity values in said resulting image.

6. The method according to claim 1, wherein the method comprises a preliminary step of removing undesired anatomical features from the digital image.

7. The method according to claim 1, wherein increasing the luminance contrast further comprises:
applying, on said digital image, said band-pass filter with at least one different parameter value, in order to generate at least one additional filtered image,
combining the at least one additional filtered image to generate the resulting image.

8. An image processing method, comprising:
acquiring a digital image,
segmenting the acquired image using a method according to claim 1,
automatically identifying at least one property of the at least one structure of interest of the segmented image.

9. The image processing method of claim 8, wherein said method further comprises a step of performing a diagnosis based on the at least one property of the at least one structure of interest of the segmented image.

10. A system for processing a digital image, said system being configured to:
a) convert pixel intensity values of the digital image into luminance values using a gamma function,
b) increase the luminance contrast between at least one structure of interest of the digital image and the digital image background,
c) segment the resulting image using a local segmentation threshold,
wherein increasing the luminance contrast comprises applying, on said digital image, a band-pass filter configured to increase the luminance of image elements having a spatial frequency comprised in a predefined interval corresponding to the spatial frequency of the structure of interest.

11. The system of claim 10, wherein, in order to segment said resulting image, the system is further configured to:
generate a blurred image by applying statistical noise on a copy of said resulting image,
shift the pixel intensity values of the blurred image by a fixed offset, and
threshold said resulting image by using, as a threshold cutoff value, for each pixel of said resulting image, the pixel intensity value of the shifted pixel intensity value.
